(19) United States
(12) Patent Application Publication
(10) Pub. No.: US 2024/0364250 A1
(43) Pub. Date: Oct. 31, 2024

(54) EXTERNALLY EXCITED ELECTRIC MACHINE WITH A NATURAL BOOST VOLTAGE

(71) Applicant: Tula eTechnology, Inc., San Jose, CA (US)

(72) Inventor: Paul CARVELL, San Jose, CA (US)

(21) Appl. No.: 18/630,634

(22) Filed: Apr. 9, 2024

Related U.S. Application Data
(60) Provisional application No. 63/499,046, filed on Apr. 28, 2023.

(51) Int. Cl. H02P 27/05

(52) U.S. Cl. CPC H02P 27/05

(57) ABSTRACT

An apparatus is provided comprising a power supply, an externally excited synchronous machine (EESM) comprising a stator and rotor, and a controller coupled between the power supply and the EESM, the controller arranged to maintain flux in the rotor during a pulsed operation, so that when the EESM is in a pulse off state flux is maintained in the rotor.

### CROSS-REFERENCE TO RELATED APPLICATION

This application claims the benefit of priority of U.S. Application No. 63/499,046, filed Apr. 28, 2023, which is incorporated herein by reference for all purposes.

### BACKGROUND OF THE INVENTION

The present application relates generally to electric machine control. More specifically, control schemes and controller designs that provide a pulsed operation of an electric machine during selected operating conditions to facilitate operating the electric machine in a more energy efficient manner.

The term “electric machine” as used herein is intended to be broadly construed to mean both electric motors and generators. Electric motors and generators are structurally very similar. Both include a stator having a number of poles and a rotor. When an electric machine is operating as a motor, it converts electrical energy into mechanical energy. When operating as a generator, the electric machine converts mechanical energy into electrical energy.

Electric motors and generators are used in a very wide variety of applications and under a wide variety of operating conditions. In general, many modern electric machines have relatively high energy conversion efficiencies. The energy conversion efficiency of most electric machines, however, can vary considerably based on their operational load. With many applications, an electric machine is required to operate under a wide variety of different operating load conditions. As a result, many electric machines operate at or near the highest levels of efficiency at certain times, while at other times, they operate at lower efficiency levels.

Battery powered electric vehicles provide a good example of an electric machine operating at a wide range of efficiency levels. During a typical drive cycle, an electrical vehicle will accelerate, cruise, decelerate, brake, corner, etc. Within certain rotor speed and/or torque ranges, the electric machine operates at or near its most efficient operating point, i.e., its “sweet spot”. Outside these ranges, the operation of an electric machine is less efficient. As driving conditions change, the electric machine transitions between high and low operating efficiency levels as the rotor speed and/or torque demand change. If the electric machine could be made to operate a greater proportion of a drive cycle in high efficiency operating regions, the range of the vehicle for a given battery charge level would be increased. Since the limited range of battery powered electric vehicles is a major commercial impediment to their use, extending the operating range of the vehicle is highly advantageous.

Although the energy conversion efficiency of conventional electric machines is generally good, there are continuing efforts to further improve energy conversion efficiencies over broader ranges of operating conditions.

### SUMMARY

A variety of methods, controllers, and electric machine systems are described that facilitate pulsed control of multiple electric machines (e.g., electric motors and generators) drive systems to improve the energy conversion efficiency of the electric machines when operating conditions warrant. More specifically, an apparatus is provided comprising a power supply, an externally excited synchronous machine (EESM) comprising a stator and rotor, and a controller coupled between the power supply and the EESM, the controller is arranged to maintain flux in the rotor during a pulsed operation, so that when the EESM is in a pulse off state, flux is maintained in the rotor.

In another embodiment, a method for providing pulsed control of an externally excited synchronous machine (EESM) is provided. Power is provided through a rotor charging circuit from a power source to a rotor when the EESM is in a pulse on state. A first rotor discharge circuit of a low impedance across rotor terminals is provided when the EESM is in a pulse off state in order to maintain flux in the rotor.

These and other features of the present disclosure will be described in more detail below in the detailed description of the disclosure and in conjunction with the following figures.

### BRIEF DESCRIPTION OF THE DRAWINGS

The invention and the advantages thereof may best be understood by reference to the following description taken in conjunction with the accompanying drawings in which:

FIG. 1 is a representative Torque/Speed/Efficiency graph illustrating the energy conversion efficiency of a representative electric machine while operating as an electric motor under different operating conditions.

FIG. 2 is a map that compares the portion of the speed-load map in which efficiency is at or above 93% for different machines.

FIG. 3 is a table for an electrical machine with 144 turns.

FIGS. 4A-B illustrate a rotor circuit that may be used in an embodiment.

FIG. 5 is a schematic illustration of an oscilloscope pictures captured when testing embodiment.

FIGS. 6A-6C illustrate a rotor circuit that may be used in another embodiment.

FIG. 7 is a block diagram illustrating a system having an EESM controller 10 that enables pulsed operation of an electric machine forming part of a vehicle.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

Efficiency is extremely important for electric vehicles, as the most efficient vehicles minimize the vehicle battery cost (often 25% of the vehicle cost), reduce the volume of space the battery requires, reduce the amount of excess heat the vehicle powertrain will need to dissipate to the environment, reduce the amount of energy required to generate the electricity used to charge the vehicle and reduce the environmental impact both of charging the battery and sourcing the materials required to create the battery.

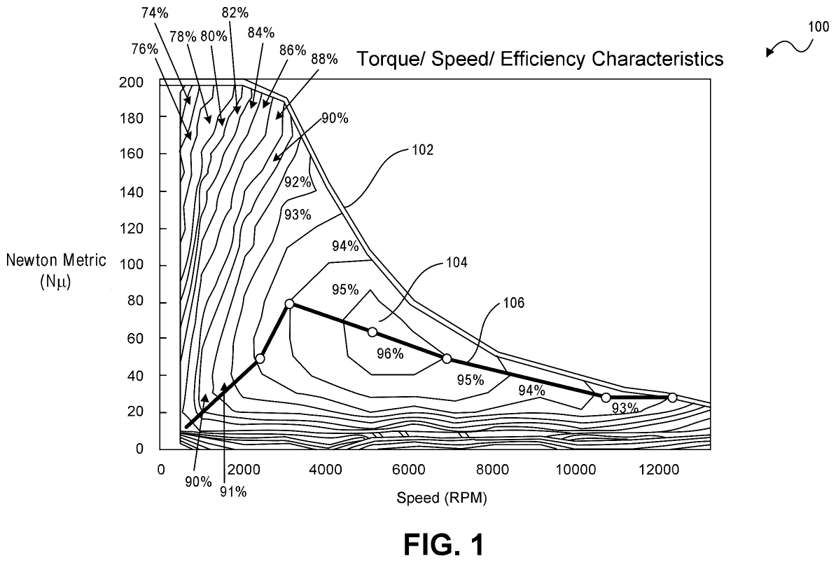

Fortunately, recent electric motors used in vehicle traction motors have peak efficiencies of over 90%, as shown in FIG. 1. Unfortunately, these peak efficiencies are not seen over a wide range of operating points. At low speeds and loads, efficiencies can be 70% or lower.

FIG. 1 is an exemplary electric machine efficiency map 100 while operating as a motor under different load and speed conditions is illustrated. It should be understood that this map 100 is merely illustrative for a permanent magnet electric motor and should not be construed as limiting in any regard. The map 100 plots torque (N*m) along the vertical axis as a function of electric machine speed (RPM) along the horizontal axis. The maximum steady-state output power (i.e., peak-torque/speed) is given by curve 102.

The area under the peak-torque/speed curve 102 is mapped into a plurality of regions, each labeled by an operational efficiency percentage. For the particular electric machine shown, the following characteristics are evident:
The most efficient or “sweet-spot” region of its operating range is the operating region labeled 104, which is generally in the range of 4,500-6,000 RPM with a torque output in the range of about 40-80 N*m. In sweet spot region 104, the energy conversion efficiency is on the order of 96%, making it the “sweet spot”, where the motor is operating in its most efficient operating range.
As the motor speed increases beyond approximately 6,000+ RPM, the efficiency tends to decrease, regardless of the output torque.
As the output torque increases beyond 80 N*m or falls below 40 N*m, the efficiency percentage tends to decrease from its peak, in some situations rather significantly. For example, when the motor is operating at approximately 2,000 RPM and an output torque of 100 N*m, the efficiency is approximately 93%. When torque output falls below about 20 N*m, regardless of the motor speed, the efficiency drops, approaching zero at zero load.
At any particular electric machine speed, there will be a corresponding most efficient output torque, which is diagrammatically illustrated by a maximum efficiency curve 106.

The map 100 is for an internal permanent magnet synchronous electric machine. Specifically, it was derived from a traction motor used in a 2010 Toyota Prius. It should be understood that this map 100 is merely illustrative and should not be construed as limiting in any regard. A similar map can be generated for just about any electric machine, regardless of whether it is used in a vehicle or in some other application.

As can be seen from the map 100, when motoring, the electric machine is generally most efficient when operating within the speed and torque ranges of the sweet spot 104. If the operating conditions can be controlled so that the motor operates a greater proportion of the time at or near its sweet spot 104, the overall energy conversion efficiency of the motor can be significantly improved.

From a practical point of view, however, many driving situations dictate that the motor operates outside of the speed and torque ranges of the sweet spot 104. In electric vehicles, it is common to have no transmission or gearbox and as such have a fixed ratio of the electric motor rotation rate to the wheel rotation rate. In this case, the motor speed may vary between zero, when the vehicle is stopped, to a relatively high RPM when cruising at highway speeds. The torque requirements may also vary widely based on factors such as whether the vehicle is accelerating or decelerating, going uphill, going downhill, traveling on a level surface, braking, etc.

As also seen in FIG. 1, at any particular speed, there will be a corresponding most efficient output torque which is diagrammatically illustrated by maximum efficiency curve 106. From a conceptual standpoint, when the desired motor torque is below the most efficient output torque for the current motor speed, the overall efficiency of the motor can be improved by pulsing the motor, so as to operate the motor a proportion of time at or near its peak efficiency for the given speed and the remainder of the time at a low or zero torque output level. The average torque thus generated is controlled by controlling the duty cycle of peak efficiency torque applied to the electric machine. It should be appreciated that the electric machine would have a similar efficiency map that characterizes its efficiency when acting as a generator.

The predominant motor architecture used in vehicles today is the interior permanent magnet (IPM) motor, which uses permanent magnets to build magnetic flux and combines that torque with reluctance torque created by the appropriate design of the rotor steel and gaps in that steel. Other motor types with permanent magnets, like surface mounted permanent magnets (SPM) are less frequently used in applications that require the highest efficiency but are also potentially used.

In general, stronger magnets create more efficient motors, and the strongest magnets in common use generally use large amounts of rare earth elements. Unfortunately, the sourcing of the magnets required for the highest-efficiency motors is environmentally problematic and economically challenging. In addition, at high speeds, magnetic flux can generate electric potential that is beyond what can be safely controlled by the powertrain. In order to avoid a dangerous operation, the motor is controlled with a technique sometimes called ‘field weakening,’ in which the stator field is developed in opposition to the permanent magnet's field, to weaken the field at high speeds. This field weakening operation is inefficient, and the high speed operation of IPM's are generally less efficient than other motor types.

In contrast, other motor types eschew permanent magnets. Those motor types include Induction Motors (IM), Switched Reluctance Motors, Synchronous Reluctance Motors (SynRM), and Externally Excited Synchronous Motors (also known as a wound field synchronous motor (WFSM) and a wound rotor synchronous motor (WRSM)). These motor types are often known by alternative names, but the function is similar or identical.

Although these motor types are not constrained in the same manner as permanent magnet based motors at high speeds, they do not benefit from the intrinsic field generation of motors that do have magnets, and as such generally offer lower efficiency at lower speeds.

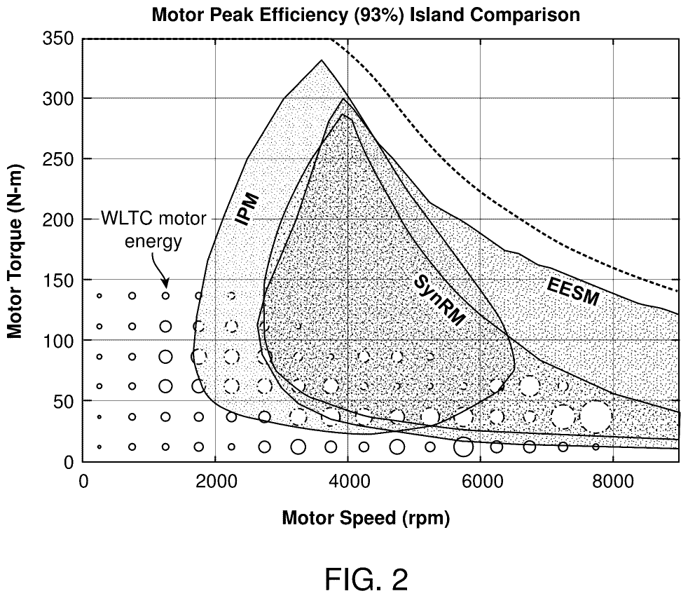

All motor types, however, have low efficiency at low loads. To illustrate this point, FIG. 2 is a map that compares the portion of the speed-load map in which efficiency is at or above 93%. The maps show for purposes of illustration Externally Excited Synchronous Motors, IPM, and SynRM motor types. The map also shows the predominant operation of an electric vehicle is at low loads; in this illustration, the area of the dots indicates the amount of energy consumed at or near those points on the Worldwide Harmonized Light-duty Test Cycle (WLTC). Although Externally Excited Synchronous Motors, SynRM, and IPM motor types are shown, SynRM motors are infrequently used in electric vehicles.

In order to expand the region of high-efficiency operation, previous patents taught pulsed electric machine control methods, such as dynamic motor drive (DMD), which intermittently operates the motor at higher loads, and then intermittently disables operation, to arrive at the desired average torque. Exemplary pulsed electric machine control systems and methods may be implemented, including those systems and methods disclosed in U.S. Pat. No. 11,133,763 issued on Sep. 28, 2021, U.S. Pat. No. 10,742,155 filed on Mar. 14, 2019, U.S. Pat. No. 10,944,352 filed on Mar. 13, 2020, U.S. patent application Ser. No. 16/912,313 filed on Jun. 25, 2020, and U.S. patent application Ser. No. 17/166,646 filed on Feb. 3, 2021, all of which are incorporated by reference in their entirety. Many techniques are possible, and many techniques are required, but in general, this operation can improve the efficiency at light loads.

For electric vehicle operation, these periods of intermittent operation often cannot exceed a total pulsed power period of 50-100 milliseconds (ms). Externally Excited Synchronous Motors designs currently in use often have time constants of 100 ms or more, which then necessitates the use of voltages beyond the steady-state voltage required in order to reduce transition time to achieve desired performance. Unfortunately, that can require power electronics that may not always be advantageous to include in the vehicle.

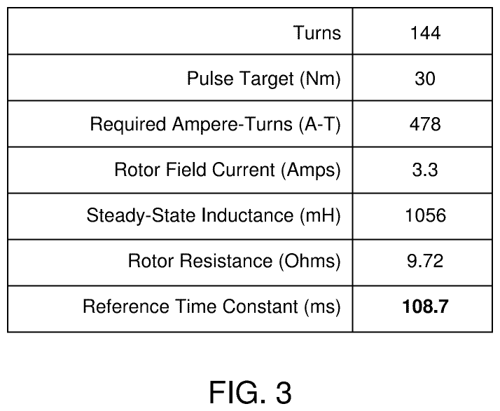

FIG. 3 is a table for Externally Excited Synchronous Motors with 144 turns and a pulse target of 30 Newton-meters (Nm) provided by 478 Amper-Turns with a rotor field current of 3.3 amperes with a steady-state inductance of 1056 millihenrys (mH) with a rotor resistance of 9.72 ohms.

### Various Embodiments

Some embodiments maintain the flux in the rotor of an Externally Excited Synchronous Motors such that the torque slew rate now approaches that of the IPM machines limited by the stator current slew rates.

From the equations governing the Externally Excited Synchronous Machine (EESM) below we can see that the

$$torque = 3. pole pairs / 2. ( - Id . Ψ q + Iq . Ψ d ) \\ and that \\ Ψ d = Ld . Id + Lm . Ir \\ Ψ q = Lq . Iq \\ Ψ r = Lm . Id + Lr . Ir .$$

We also know that the time constants for the flux build up is

$${λ}_{*}^{e} = {L}_{*} . \frac{{i}_{*}^{e}}{( {τ}_{r} s + 1 )}$$

For an EESM the time constant of most concern is the rotor time constant.

If flux cannot be built up and dissipated quickly enough for good pulsed electric machine control modulation, then we must consider what is the best way to maintain the flux during the pulsed electric machine control off period with minimal losses.

Previously it has been identified that one of the biggest contributions to the reduction in losses when using pulsed electric machine control modulation is the ability to turn off the inverters. So instead of controlling Id and Iq to zero, we will just disable the stator inverter. From the flux equations above we can see that the fluxes are reduced to

$$Ψ d = 0 + Lm . Ir \\ Ψ q = 0 \\ Ψ r = 0 + Lr . Ir$$

This is effectively a simple mutual inductance using the same core except that the secondary, stator, coil is an open circuit, which then reduces the circuit further when viewed from the rotor, as an inductor. If we now treat this as an inductor with the goal of maintaining the flux but disabling any excitation being applied for the pulsed electric machine control off period it will give the same results as that of discharging an inductor.

$$I ( t ) = {I}_{0} {e}^{- \frac{R}{L} t}$$

On inspection of the classic inductor discharge equation above we can observe that the higher the resistance the faster the current will decay or dissipate and the lower the resistance the slower it will decay or dissipate.

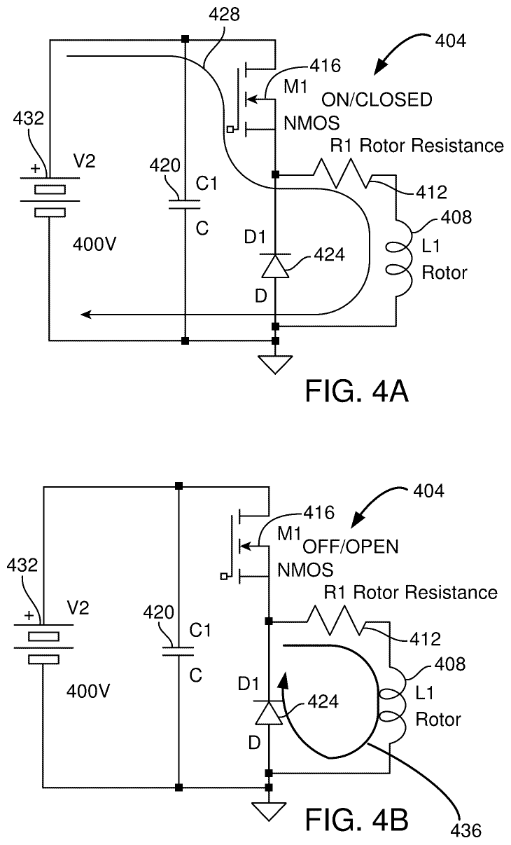

The lowest possible resistance is achieved by shorting the rotor winding resulting in a circuit resistance equal to that of the rotor. For example, FIG. 4A illustrates a rotor circuit 404 that may be used in an embodiment. The rotor 408 provides an inductance L1. The rotor circuit 404 further comprises a winding resistance 412 with resistance R1 equal to the resistance of the wire forming the rotor, a switch 416, a capacitor 420 with a capacitance C1, and a diode 424. In the “on” position, the current 428 flows from a power source 432 through the switch 416 in the closed position, through the winding resistance 412, through the rotor inductance 408, and then back to the power source 432, charging the rotor circuit. The capacitor 420 is included to ensure that the power leads to power source 432 do not induce damaging voltage transients on the discontinuity of the current. In some embodiments, the rotor circuit 404 may not have a capacitor 420.

FIG. 4B illustrates the rotor circuit 404 in a discharging state, where the switch 416 is open when the pulse is in an off state. When the switch 416 is open, the current 436 circulates through the rotor circuit of an inductive resistance (LR) circuit passing through the winding resistance 412, the rotor inductance 408, and the diode 424, discharging the stored energy in the rotor inductance.

The equations for the discharging 4B are:

$${V}_{L} = {V}_{D} then - L \frac{dI}{dt} = {R}_{L} I + {V}_{D} \\ I ( t ) = ( {I}_{0} + \frac{{V}_{D}}{{R}_{L}} ) {e}^{- \frac{{R}_{L}}{L} t} - \frac{{V}_{D}}{{R}_{L}}$$

Which leads to

$$t = - \frac{L}{{R}_{L}} ln ( \frac{{V}_{D}}{{V}_{D} + {I}_{0} {R}_{L}} )$$

As the time constant for the rotor winding is very large it falls only a small amount when the excitation, metal-oxide-semiconductor field-effect transistor (MOSFET) M1, is turned off.

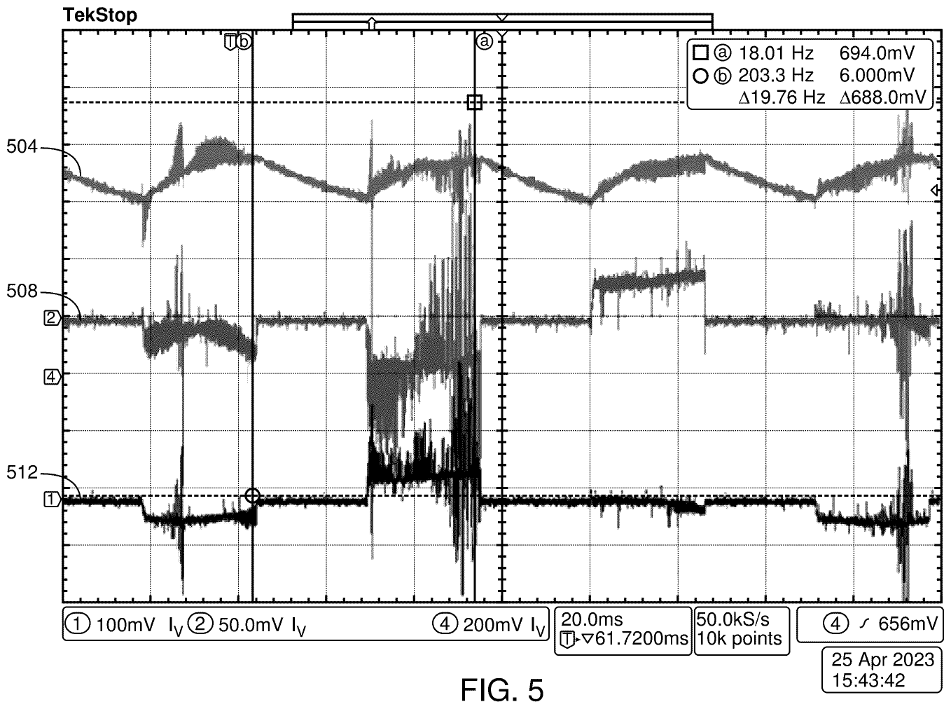

FIG. 5 is a schematic illustration of an oscilloscope picture captured when testing the embodiment. A first trace 504 tracks the rotor current. A second trace 508 and a third trace 512 track two of the stator phase currents. The average level of the rotor current is maintained by a Proportional plus Integral (PI) controller but could easily be maintained by a hysteretic controller.

The oscilloscope picture shows that the current in the first trace 504 remains at an average value and the deviation is small. Now the rotor's inductance is non-linear and reduces and the magnetic circuit saturates due to increasing current. As in this case, the current deviation is small, we can say that the rotor inductance deviation is small so stays at an average value. As a result, the flux (current*inductance) also stays at an average value even when the rotor excitation is turned off.

In some embodiments, in the above circuit, the diode could be replaced by a second MOSFET to lower the voltage drop, and hence the decay rate of the inductor charge would be lower. In some embodiments, any switching devices could be used to replace the MOSFETs, and with due consideration, operate the circuit in the same manner.

Maintaining the rotor flux will make the EESM behave as if the EESM was a permanent magnet machine. This presents 2 problems.

One, at some speed the induced stator back EMF (BEMF) will exceed the available high voltage bus. Under these circumstances, it may be prudent to either not operate in pulsed electric machine control mode by maintaining both the stator and rotor energized (i.e., not turning off the stator inverter or the rotor converter) or to alternatively discharge some of the rotor stored energy back to the high voltage bus so reducing the flux to a level that induces a stator BEMF that is less than the high voltage bus, that provides a voltage threshold.

And two, as the flux is maintained during the off period, magnetic core losses will also exist during the off period.

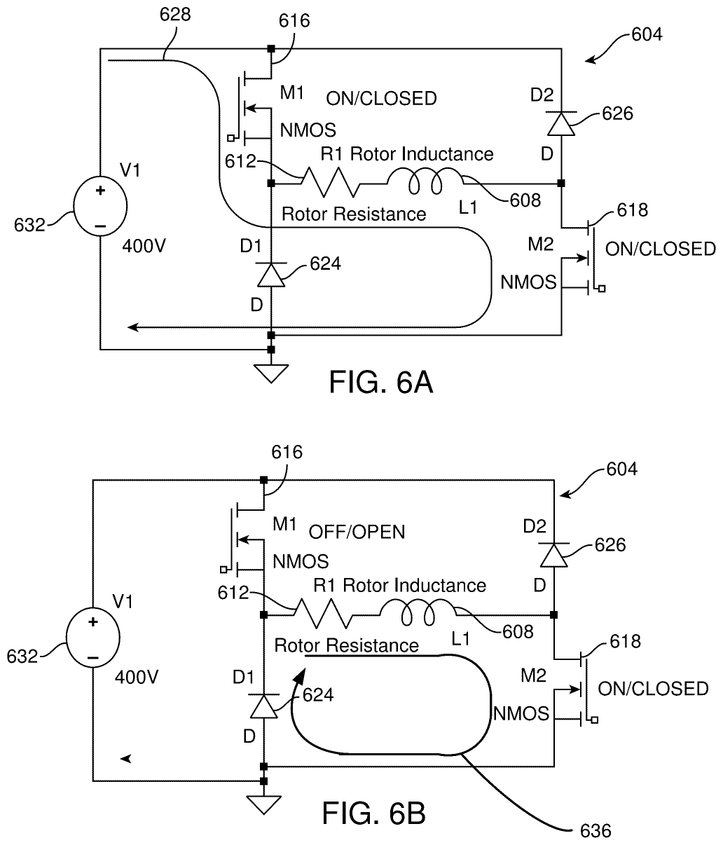

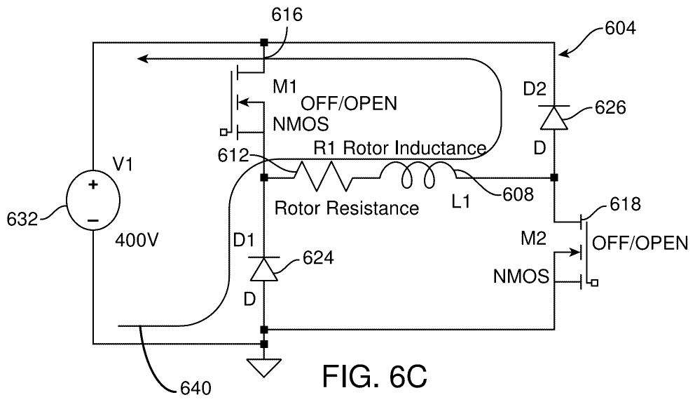

The rotor circuit 404 may be changed to accommodate fast discharging of some of the rotor stored energy back to the high voltage bus. FIG. 6A illustrates a rotor circuit 604 that may be used in an embodiment, where the rotor circuit has more components that allow a fast discharge. The rotor circuit 604 comprises a rotor 608 with a winding inductance L1, a winding resistance 612 with resistance R1, a first switch 616, a second switch 618, a first diode 624, and a second diode 626 connected to a power source 632. In a rotor charging state, the first switch 616 and the second switch 618 are closed. The current 628 goes through a rotor charging circuit from a power source 632 through the first switch 616, through the resistor 612, through the rotor 608, through the second switch 618, and then back to the power source 632.

FIG. 6B illustrates the rotor circuit 604 in a discharging state where the first switch 616 is open and the second switch 618 is closed. When the first switch 616 is open, the current 636 discharges through a first rotor discharging circuit of an inductive resistance (LR) circuit passing through the winding resistance 612, the rotor inductance 608, the second switch 618, and the first diode 624.

FIG. 6C illustrates the rotor circuit 604 in a fast rotor discharging state where the first switch 616 is open and the second switch 618 is open. The current 640 discharges through a second rotor discharging circuit of the first diode 624, through the winding resistance 612, the rotor inductance 608, and the second diode 626 returning power to the power source 632. The current 640 from the discharging rotor inductance 608 is able to be stored as power in the power source 632. The second rotor discharging circuit is able to discharge the rotor faster than the first rotor discharging circuit. In some embodiments, the first rotor discharging circuit is called a slower rotor discharging circuit, and the second rotor discharging circuit is called a faster rotor discharging circuit. The second rotor discharging circuit may be used in other circumstances when desired for other fast discharging purposes. For example, it is desirable to discharge the rotor flux fast such as under motor or stator inverter fault conditions where it is desirable to ensure the BEMF remains below what is sustainable by the power supply such that no uncontrolled current is generated possibly causing damage to the battery or fuse or even uncontrollable vehicle declaration.

For an EESM, in the pulsed electric machine control off period excitation for the stator and rotor can be turned off, thereby saving on the switching and conduction losses in the stator inverter and the switching losses in the rotor converter. As either the diode or an alternative switch that replaces the diode will be in conduction in the pulsed electric machine control off period, the pulsed electric machine control off conduction losses of the rotor converter cannot be saved.

However, the time taken to re-establish the rotor flux to the required level is very small hence the torque pulse amplitude for pulsed electric machine control can be established much quicker than for that where the rotor current is reduced to zero in the OFF period.

This ability to re-establish the rotor flux quickly can be accomplished by deliberately returning some but not all of the stored energy in the rotor magnetic circuit to the power source 632. The pulsed electric machine control speed range can be extended beyond the electric machine's corner point into the field weakening region without needing to apply negative Id current in the stator.

Some embodiments provide a simple implementation requiring a minimum of a single switch with a parallel diode and gate driver. With an additional switch and diode, the rotor energy can be returned to the high voltage bus, in order to reduce the rotor flux sufficiently to maintain the natural BEMF of the stator winding (not field weakened by the application of negative Id) to less than the inverter applied voltage from the battery. In some embodiments, this results in less core losses than the field weakening region of an equivalent IPM machine due to the ability to reduce the rotor flux by returning the energy from the rotor back to the supply thereby reducing the magnetic flux in the electric machine and hence the core losses generated as it rotates. Some embodiments provide the ability to trade the flux level by returning a percentage of the energy stored in the rotor to the power supply and hence reduced core losses during the pulsed electric machine control OFF period versus the rate at which the torque can be re-established for the pulsed electric machine control ON period.

In maintaining a current flowing in the rotor winding, a flux is maintained in the rotor winding, inducing a flux in the stator winding. This flux results in core losses within the magnetic material even though the inverter and rotor converter are effectively OFF. These losses are similar to those generated in an IPM by the permanent magnet placed in the rotor. Some embodiments allow faster slew rates in pulsed electric machine control for EESM due to retaining the magnetic field flux at or near an optimal level.

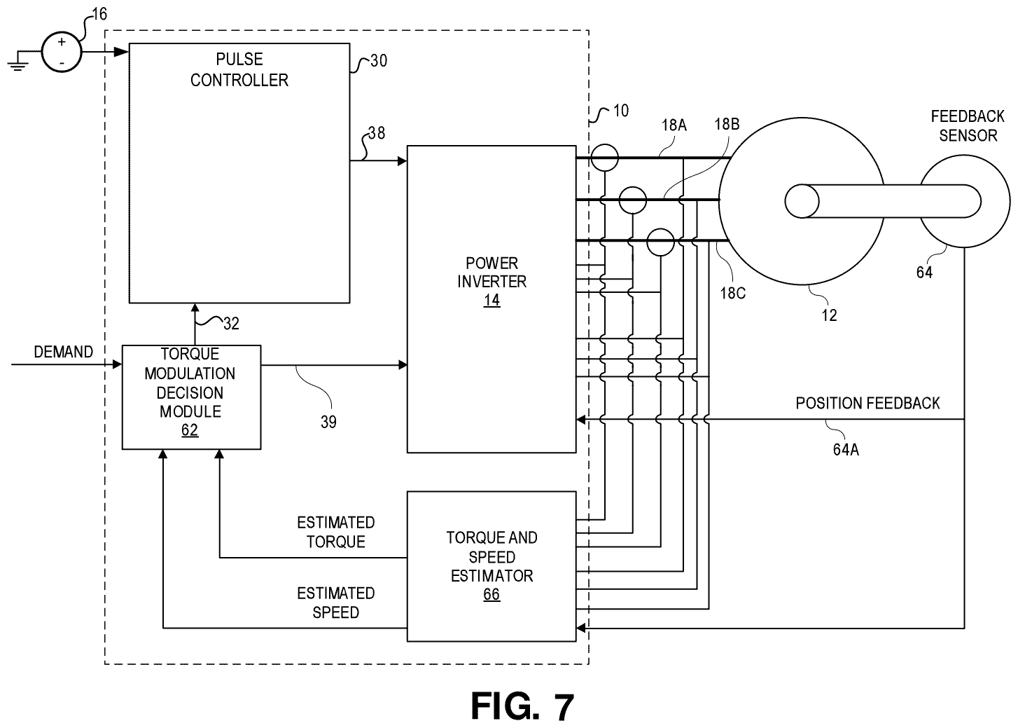

FIG. 7 is a block diagram illustrating a system having an EESM controller 10 that enables pulsed operation of an electric machine 12 forming part of a vehicle. In some embodiments, the electric machine 12 may be an EESM. The illustrated electric machine 12 is a three-phase electric machine although it should be appreciated that the electric machine may be designed to utilize any desired number of phases including just a single phase. In some embodiments, the EESM controller provides the pulsed operation of an electric machine for other mechanical actuators instead of vehicles.

The electric machine controller 10 includes a power inverter 14, a pulse controller 30, and a torque modulation decision module 62. The power inverter 14 may be operated as a power inverter or power rectifier depending on the direction of energy flow through the system.

When the electric machine 12 is operated as a motor, the power inverter 14 is responsible for generating three-phase AC power (denoted as 18A, 18B, and 18C for phases A, B, and C respectively) from the DC power supply 16. The three-phased input power is applied to the windings of the stator of the electric machine 12 for generating a Rotating Magnetic Force (RMF). In an induction motor, this rotation field induces current to flow in the rotor winding which in turn induces a rotor magnetic field. The interaction of the rotor and stator magnetic fields generates an electromagnetic force (EMF) causing rotation of the rotor, which in turn rotates a motor shaft. The rotating shaft provides the output torque of the motor.

The three phases, 18A-18C are each depicted by lines with arrows on both ends indicating that current can flow in either direction. When used as a motor, current flows from the power supply 16, through the power inverter 14, to the electric machine 12. When used as a generator, the current flows from the electric machine 12, through the power inverter 14, to the power supply 16. When operating as a generator, the power inverter 14 essentially operates as a power rectifier, and the AC power coming from the electric machine 12 is converted to DC power being stored in the DC power supply, such as a battery or capacitor.

The pulse controller 30 is responsible for selectively pulsing the three-phased sinusoidal input current signals 18A-18C to the electric machine 12. During conventional (i.e., continuous) operation, the three-phased input current provided to the electric machine 12 are continuous sinusoidal current signals, each 120° degrees out of phase with respect to one another. During pulsed operation, the three-phased sinusoidal current signals 18A-18C are selectively pulsed.

During the operation of the electric machine, the torque modulation decision module 62, also called a pulsing decision module, receives a torque demand. In response, the torque modulation decision module 62 makes a determination of whether the requested torque demand is more or less than a designated “pulsing” threshold associated with the current machine speed. In most embodiments, the pulsing threshold will vary as a function of the speed of the electric machine 12. In some embodiments, the pulsing threshold for a given speed may be at or near the peak efficiency torque of the electric machine 12 for that speed. However, that is not a requirement. It should be appreciated that there are a number of factors that may go into the determination of the appropriate pulsing threshold for any particular motor/generator speed. The net operational efficiency of the electric machine, or a larger system that includes the electric machine is one important factor in the determination of the pulsing threshold as will be discussed in more detail below. However, other factors (e.g., NVH mitigation concerns) may be considered as well.

When the torque demand is higher than the pulsing threshold, the torque modulation decision module 62 directs the electric machine 12 to operate in a continuous mode. In this case, torque demand is passed to the inverter 14 as inverter control signal 39 in a traditional manner, and the inverter 14 directs the operation of the electric machine in a continuous manner to deliver the desired torque.

When the torque demand is less than the pulsing threshold, the torque modulation decision module 62 determines the desired pulsed control operational state. The desired pulsed control operational state is passed via 32 to pulse controller 30 which then directs the operation of the inverter 14 via inverter control signal 38. In this context, the pulsing operational state may include an indication of whether pulsed control is enabled, and if so, (a) the desired target output level when during the torque on periods (sometimes referred to as the target pulse torque); (b) the desired pulsing duty cycle; and (c) whether the inverter should remain active or be deactivated during the no torque periods. In practice, the characteristics of the electric machine, the combination of the electric machine and its control system, and/or a larger system that includes the electric machine/machine controller may be characterized through the creation of operational maps such as the efficiency maps described above. Based on such maps, the most efficient operational state for any and all operating conditions (e.g., all possible machine speed and output level combinations) can be determined. In some embodiments, this information may be stored in a data structure such as a lookup table that may be utilized by torque modulation decision module 62 to determine the appropriate operating state for any commanded output (e.g., torque demand) based on the current machine speed, and any other relevant control parameters. In other embodiments, the torque modulation decision module 62 may use algorithmic or other suitable approaches to make such decisions.

In the embodiment illustrated in FIG. 7, the pulse controller is shown as a component that is separate from the torque modulation decision module 62 to facilitate an explanation of its function. However, in various embodiments, the pulse controller may be implemented as part of a machine controller that includes the torque modulation decision module 62, as a separate component, as part of the power controller/inverter 14, or in other appropriate forms. Some of the basic functions and operation of representative pulse controllers 30 are described in the incorporated U.S. patent application Ser. Nos. 16/353,159 and 16/353,166.

In some embodiments, the controller is able to maintain flux in the rotor during a pulsed operation by providing a first rotor discharge circuit that slowly discharges the rotor in proportion to the time constant of the rotor, by providing a low impedance path across the rotor terminals, so that when the EESM is in a pulse off state flux is maintained in the rotor. In the specification and claims, a low impedance is defined as an impedance that is less than the resistance of the rotor divided by 100 (i.e. low impedance <R1/100). The time constant of the rotor is related to the inductance of the rotor. In a pulsed operation with a period of less than 100 ms, by directing the discharging current through the rotor windings the rotor time constant prevents the flux from going to zero, and therefore the flux is maintained during pulsing. In some embodiments, in a pulsed operation with a pulse period of less than 100 ms, the flux is maintained so that the flux remains almost constant. In some embodiments, the EESM has a rotor time constant of greater than 0.1 s and a pulse period of less than 0.02 s. If a 70% on duty cycle is provided, then the drop in flux is about 1−e^{-0.7*0.2}/0.1, which is about 13%. Such a drop in flux can be seen in the drop indicated by the first trace 504, shown in FIG. 5. Therefore, in some embodiments with a pulse period of less than 0.02 s and a duty cycle with greater than 50% on, the flux is reduced by less than 20% during the pulse off period of each pulse. The pulse controller may be part of a larger control system. For example, in vehicular applications, the pulse controller may be part of a vehicle controller, a powertrain controller, a hybrid powertrain controller, or an ECU (engine control unit), etc. that performs a variety of functions related to vehicle control. In such applications, the vehicle or other relevant controller, etc. may take the form of a single processor that executes all of the required control, or it may include multiple processors that are co-located as part of a powertrain or vehicle control module or that are distributed at various locations within the vehicle. The specific functionalities performed by any one of the processors or control units may be widely varied.

The invention has been described primarily in the context of motor control and/or inverter/motor control. However, it should be appreciated that the described approach is equally applicable to generator and/or generator/rectifier control. Thus, any time that motor control is described it should be appreciated that analogous techniques can be applied to generator control. Thus, unless the context requires a different interpretation, a description of a feature of pulsed motor control, pulsed generator control, or pulsed motor/generator control should be understood to apply equally to pulsed motor control, pulsed generator control, and the pulsed control of combined motor/generators.

A variety of different control schemes can be implemented within the pulse controller. Generally, the control schemes may be implemented digitally, algorithmically, using analog components, or using hybrid approaches. The pulse generator and/or the motor controller may be implemented as code executing on a processor, on programmable logic such as an FPGA (field programmable gate array), in circuitry such as an ASIC (application specific integrated circuit), on a digital signal processor (DSP), using analog components, or any other suitable piece of hardware. In some implementations, the described control schemes may be incorporated into object code to be executed on a digital signal processor (DSP) incorporated into an inverter controller (and/or rectifier controller in the context of a generator and/or a combined inverter/rectifier controller).

In various embodiments, pulse width modulation, sigma-delta conversion, or other techniques may be used to create the pulsed inverter control signal 38. Regardless of the type of modulation used, the transitions between pulsing levels may be managed in the described manner. Therefore, the present embodiments should be considered illustrative and not restrictive, and the invention is not to be limited to the details given herein but may be modified within the scope and equivalents of the appended claims.

While this disclosure has been described in terms of several preferred embodiments, there are alterations, modifications, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, modifications, permutations, and various substitute equivalents as fall within the true spirit and scope of the present disclosure. As used herein, the phrase “A, B, or C” should be construed to mean a logical (“A OR B OR C”), using a non-exclusive logical “OR,” and should not be construed to mean ‘only one of A or B or C. Each step within a process may be an optional step and is not required. Different embodiments may have one or more steps removed or may provide steps in a different order. In addition, various embodiments may provide different steps simultaneously instead of sequentially.

What is claimed is:

1. An apparatus, comprising:
a power supply;
an externally excited synchronous machine (EESM) comprising a stator and rotor; and
a controller coupled between the power supply and the EESM, the controller arranged to maintain flux in the rotor during a pulsed operation, so that when the EESM is in a pulse off state flux is maintained in the rotor.

2. The apparatus, as recited in claim 1, wherein the controller comprises:
a rotor circuit for providing power to the rotor, wherein the rotor circuit comprises:
a rotor charging circuit for providing power from the power supply to the rotor; and
a first rotor discharging circuit that causes the rotor to discharge over a time proportional to a time constant of the rotor; and
a pulse controller, wherein the pulse controller directs a pulsed operation of the EESM, wherein the pulsed operation provides a pulsed power to the rotor with a pulse period, wherein the pulse period of less than 100 ms, wherein during part of the pulse period current flows through the first rotor discharging circuit, wherein when the current flows through the first rotor discharging circuit, a flux of the rotor is decreased as a function of the rotor time constant.

3. The apparatus as recited in claim 2, wherein the rotor circuit comprises a first switch for switching between the rotor charging circuit and the first rotor discharging circuit.

4. The apparatus, as recited in claim 3, wherein the rotor circuit further comprises a second rotor discharging circuit, wherein the second rotor discharging circuit returns power from the rotor to the power supply and wherein the second rotor discharging circuit discharges the rotor faster than the first rotor discharging circuit.

5. The apparatus, as recited in claim 4, wherein the rotor circuit further comprises a second switch for switching between the first rotor discharging circuit and the second rotor discharging circuit.

6. The apparatus, as recited in claim 5, wherein when a back EMF (BEMF) of the EESM can no longer be sustained by the power supply for a rotor flux present when discharging the rotor through the first rotor discharging circuit, the rotor circuit is switched to the second rotor discharging circuit in order to reduce the rotor flux fast enough to sustain the BEMF of the EESM to a sustainable BEMF.

7. The apparatus, as recited in claim 6, wherein when the BEMF is sustainable the rotor circuit is switched back to the first rotor discharging circuit.

8. The apparatus, as recited in claim 5, wherein the second rotor discharging circuit is the same circuit that would allow fast discharge of the rotor when desirable.

9. The apparatus, as recited in claim 2, wherein the rotor has an impedance and the first rotor discharging circuit has a resistance wherein the impedance of the rotor is less than the resistance of the first rotor discharging circuit divided by 100.

10. The apparatus, as recited in claim 1, wherein the first rotor discharging circuit is arranged so that for a pulse period of less than 0.02 s and a duty cycle with greater than 50% on, the flux is reduced by less than 20% during the pulse off period of each pulse.

11. A method for providing pulsed control of an externally excited synchronous machine (EESM), the method comprising:
providing power through a rotor charging circuit from a power source to a rotor when the EESM is in a pulse on state; and
providing a first rotor discharge circuit of a low impedance across rotor terminals when the EESM is in a pulse off state in order to maintain flux in the rotor.

12. The method, as recited in claim 11, further comprising:
providing a pulsed operation of the EESM, wherein the pulsed operation has a pulse period of less than 100 ms, wherein a low impedance path across the rotor decreases the flux at a rate controlled only by a rotor time constant during an off period.

13. The method, as recited in claim 12, further comprising providing a second rotor discharging circuit that returns power from the rotor to a power supply, wherein the second rotor discharging circuit discharges the rotor faster than the first rotor discharging circuit.

14. The method, as recited in claim 13, further comprising switching between the rotor charging circuit and the first rotor discharging circuit.

15. The method, as recited in claim 14, further comprising switching from the first rotor discharging circuit to the second rotor discharging circuit when a back EMF can no longer be sustained by the power supply.

16. The method, as recited in claim 15, further comprising switching back to the first rotor discharging circuit when the BEMF is sustainable.

17. The method, as recited in claim 16, further comprising switching to the second rotor discharging circuit for other fast discharge purposes.

18. The method, as recited in claim 11, wherein the rotor has an impedance and the first rotor discharging circuit has a resistance wherein the impedance of the rotor is less than the resistance of the first rotor discharging circuit divided by 100.

19. The method, as recited in claim 11, wherein the first rotor discharging circuit is arranged so that when the EESM is in a pulse off state flux is maintained in the rotor so that for a pulse period of less than 0.02 s and a duty cycle with greater than 50% on, the flux is reduced by less than 20% during the pulse off period of each pulse.
